(19) United States
(12) Patent Application Publication
(10) Pub. No.: US 2024/0339884 A1
(43) Pub. Date: Oct. 10, 2024

(54) Sliding Cover, Method for Mounting the Sliding Cover, and Tool for Implementing the Method

(71) Applicant: Innomotics GmbH, Nuernberg (DE)

(72) Inventors: Vladislav JOSIEK, Havírov, Czech Republic (CZ); Michael BERNHARDT, Bad Neustadt (DE); Klaus KIRCHNER, Ostheim (DE); Jan UHEREK, Trinec, Czech Republic (CZ)

(21) Appl. No.: 18/574,426

(22) PCT Filed: Jun. 24, 2022
(86) PCT No.: PCT/EP2022/067383

§ 371 Date: Dec. 27, 2023

(30) Foreign Application Priority Data
Jun. 29, 2021 (EP) 21182538

(51) Int. Cl. H02K 3/487; H02K 15/00

(52) U.S. Cl. CPC H02K 3/487; H02K 15/0018

(57) ABSTRACT

A sliding cover, particularly for closing a slot in a stator of an electric motor, wherein the sliding cover is folded as an open trapezoid made of a planar insulation material, and the front end of the sliding cover in the direction of insertion is provided with a locking element for a catch such that the sliding cover is easier and faster to mount.

### CROSS-REFERENCE TO RELATED APPLICATIONS

This is a U.S. national stage application No. of PCT/EP2022/067383 filed 24 Jun. 2022. Priority is claimed on European Application No. 21182538.5 filed 29 Jun. 2021, the content of which is incorporated herein by reference in its entirety.

### BACKGROUND OF THE INVENTION

### 1. Field of the Invention

The invention relates to a sliding cover, a method for mounting a sliding cover and a tool for implementing the method.

### 2. Description of the Related Art

Electric motors typically have a so-called stator with a hollow-cylindrical, magnetically conductive body that has on one of its lateral surfaces partially open slots which run in a substantially axially manner and in which windings are arranged.

When the windings are introduced into the stator, planar insulation materials are also inserted therewith into the slots. A “slot box” serves as the slot lining. This is a folded planar insulation material that is adapted in terms of its cross-sectional shape to the contour of the slot and that bears against the slot wall.

The slot lining forms an additional planar electrical barrier between the winding system, in particular between the copper windings made of enameled wire and the magnetically conductive body of the stator.

After the introduction of the winding, the slot opening is closed by a sliding cover that also consists of a folded planar insulation material and that has two important functions. Firstly, the required air gaps and creepage distances are implemented thereby, because the sliding cover and the slot box overlap on the edges. Secondly, the slot box is wedged with the slot tooth and thus mechanically fixes the winding in the slot so that no individual wires can slip back through the slot opening into the region of the air gap or the rotor.

The insertion of sliding covers can occur either in a manual or automated manner. In the manual method, the sliding cover is positioned from the stator front face on the slot, which is already provided with a winding and basic insulation, and is axially pushed into the slots.

With partially automated mounting, as disclosed, for example, in DE 26 30 183 A1, the sliding cover is pressed together with the windings into the slot via a tool that is already provided with the sliding covers and pre-wound coils.

### SUMMARY OF THE INVENTION

It is an object of the present invention to simplify the mounting of a sliding cover relative to the prior art.

this and other objects and advantages are achieved in accordance with the invention by a sliding cover, where the front end of the sliding cover in the direction of insertion is provided with a locking element for a catch.

The locking element can advantageously be configured as a recess in a tapering front region of the sliding cover.

In an advantageous embodiment of the locking element, a fold is attached to the front edge of the sliding cover in the direction of insertion.

The insertion of the sliding cover is thus simplified via a tool that engages in the locking element. The tool can be used both with manual mounting and also with automated mounting.

To this end, the tool preferably has a rotatably mounted base body, a projection protruding as a catch from the base body, and a spring element, where during the insertion process the catch is pushed thereby toward the sliding cover such that during a forward movement the catch protrudes toward the locking element.

An advantageous embodiment of the tool is achieved when the rotatably mounted base body has a planar configuration and the contour thereof corresponds approximately to a bell shape and when a rhombus-shaped projection protrudes as a catch from the bell base.

The objects and advantages are also achieved in accordance with the invention by a method for mounting a sliding cover in a slot of the stator of an electric motor, when the front end of the sliding cover is fitted into a slot to be closed of a stator of an electric motor, when the tool for mounting a sliding cover is then positioned on the lateral surface of the stator such that the catch bears against the locking element, and when the tool is moved thereon in the slot direction and thus the sliding cover is introduced.

The sliding cover in accordance with the invention can also be inserted via the tool, even in the case of fully automated production.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail by exemplary embodiments shown in the figures, in which:

FIG. 1 shows a section through a stator of an electric machine;

FIG. 2 shows a first embodiment of a sliding cover in accordance with the invention;

FIG. 3 shows a second embodiment of a sliding cover in accordance with the invention;

FIG. 4 shows an exemplary tool for mounting the sliding cover in accordance with the invention; and

FIG. 5 shows a flowchart of the method in accordance with the invention.

### DETAILED DESCRIPTION OF THE EXEMPLARY EMBODIMENTS

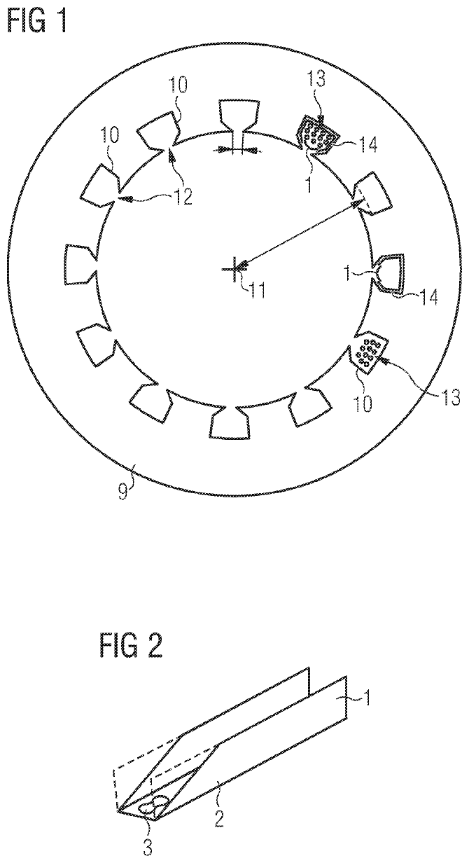

As shown in FIG. 1, the stator 9 of an electric machine has a plurality of stator slots 10. The stator slots 10 extends parallel to the axis of rotation 11 of the electric machine. The stator slots are arranged so as to be distributed in a circular manner about the axis of rotation 11. The stator slots 10 are open toward the axis of rotation 11, i.e., radially inwardly. The stator slots 10 have a tapered region 12 at the end thereof facing the axis of rotation 11.

The main portions of the windings 13 of a stator winding system are arranged in the stator slots 10.

When the windings 13 are introduced into the stator, planar insulation materials are also inserted into the slots. A “slot box” 14 serves as the slot lining. This slot box is a folded planar insulation material that is adapted in terms of its cross-sectional shape to the contour of the slot 10 and bears against the slot wall.

The slot lining forms an additional planar electrical barrier between the copper windings 13 made of enameled wire and the magnetically conductive body of the stator 9.

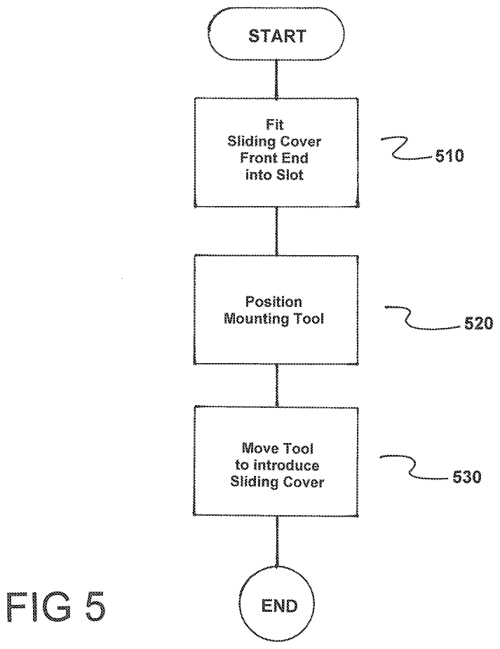

After the introduction of the winding, the slot opening is closed by a sliding cover 1, the exemplary embodiments thereof in accordance with the invention are described in more detail with reference to FIGS. 2 and 4.

The sliding cover 1 as illustrated in FIG. 2 2 is formed as a trapezoid that is made of a planar insulation material and that is open in the longitudinal direction. The dimensions thereof are adapted to the slot that is respectively to be closed.

Sliding covers can be produced from materials of all insulation material classes. The majority of sliding covers are produced from polyester film (Mylar, Hostaphan), DMD (Triflexil, Evitherm, Voltaflex, Flexiso), NMN (Triflexil, Trivoltherm, Isonom, Flexiso) and Nomex.

The sliding cover in accordance with the invention has, at its front end in the direction of insertion, a tapered portion 2 that is formed by chamfering the side surfaces of the trapezoid. In the tapering region, a recess 3 is provided as a locking element in the bottom face of the trapezoid. The contour of the recess can correspond, for example, to a figure of eight.

As evident in FIG. 4, during the mounting process, i.e., while the sliding cover 1 is being introduced into the slot of a stator of an electric motor, the catch 6 of the tool engages in the recess 3 such that when the tool is moved a force can be applied in the direction of insertion onto the sliding cover 1 and the movement of the tool brings about a corresponding movement of the sliding cover 1 in the slot.

The exemplary tool, as shown in FIG. 4 4, has a base body 5 on which it is mounted at a pivot point 8, and during the forward movement is held via the spring element 7 in a working position in which the catch 6 of the tool engages in the recess 3.

However, if the tool moves backward, i.e., when the tool is withdrawn after the sliding cover 1 has been inserted into the slot, then the catch is pulled out of the recess 3 counter to the spring force and slides back into its initial position on the bottom face of the sliding cover 1 closing the slot before the insertion process for the next sliding cover 1 is started.

An advantageous shape for the base body 5 has proved to be an approximate bell shape, the one side thereof forming a stop in a working position during the forward movement, and in conjunction with the spring element 7 fixing the position of the catch 6 in the recess 3.

This catch 6 preferably protrudes from the bell base as a rhombus-shaped projection, where in the working position a side surface of the rhombus extends parallel to the bottom face of the sliding cover 1 and two side surfaces of the rhombus are at an angle of approximately 45° to the bottom face of the sliding cover 1 in the direction of introduction.

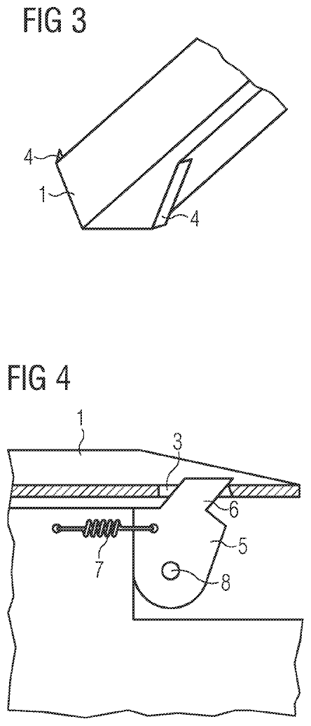

A second embodiment of a sliding cover 1 in accordance with the invention can be seen in FIG. 3. In this version, the sliding cover 1 has on its front face a fold 4, an edge being produced thereby in the path of the sliding cover 1 and serving as a locking element for the catch during the insertion process.

The addition of a fold 4 can be performed in a simple manner with thermally deformable plastics, i.e., thermoplastics, and thus represents an advantageous alternative to the embodiment that is generally manufactured via stamping tools in accordance with FIG. 1.

The sliding covers in accordance with the disclosed embodiments of the invention also enable, in particular, (partially) automated production, for example, in conjunction with the automated mounting of windings, as disclosed in WO 2020/058048 A1. A winding tool for mounting a winding is additionally provided with sliding covers and the tool for mounting a sliding cover.

FIG. 5 is a flowchart of the method for automated mounting of a sliding cover in a slot of a stator of an electric motor. The method comprises fitting a front end of the sliding cover 1 into a slot to be closed of a stator of an electric motor, as indicated in step 510.

Next, the tool for mounting the sliding cover is positioned on a lateral surface of the stator such that the catch 6 bears against a locking element, as indicated in step 520.

Next, the tool is moved thereon in the slot direction to introduce the sliding cover 1, as indicated in step 530.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A sliding cover for closing a slot in a stator of an electric motor, the sliding cover being folded as an open trapezoid made of a planar insulation material, and the sliding cover comprising:
a locking element for a catch, the locking element being arranged at a front end of the sliding cover in a direction of insertion.

9. The sliding cover as claimed in claim 8, wherein the sliding cover include tapered portion on the front end in the direction of insertion, and wherein the locking element is formed as a recess tapering region.

10. The sliding cover as claimed in claim 8, wherein the locking element is formed as a fold in the front edge of the sliding cover the catch in the direction of insertion of the sliding cover.

11. A tool for mounting the sliding cover as claimed in claim 8, the tool comprising:
a rotatably mounted base body is provided, a projection formed as the catch protruding from a base body; and
a spring element, during an insertion process the catch being pushed thereby toward the sliding cover such that during a forward movement the catch protrudes toward the locking element.

12. The tool as claimed in claim 11, wherein the rotatably mounted base body has a planar configuration and the contour thereof corresponds approximately to a bell shape; and wherein a rhombus-shaped projection protrudes as the catch from a bell base.

13. A method for automated mounting of a sliding cover in a slot of a stator of an electric motor, the method comprising:
fitting a front end of the sliding cover into a slot to be closed of a stator of an electric motor;
positioning the tool for mounting the sliding cover on a lateral surface of the stator such that the catch bears against a locking element; and
moving the tool is moved thereon in the slot direction to introduce the sliding cover.

14. The method for the automated mounting of a sliding cover in the slot of the stator of the electric motor as claimed in claim 13, wherein a winding tool for mounting a winding is additionally provided with sliding covers and the tool for mounting the sliding cover.
